(19) United States
(12) Patent Application Publication
(10) Pub. No.: US 2025/0004672 A1
(43) Pub. Date: Jan. 2, 2025

(54) NON-TRANSITORY COMPUTER-READABLE RECORDING MEDIUM CONTAINING COMPUTER-EXECUTABLE INSTRUCTIONS WHICH CAUSES INFORMATION PROCESSING DEVICE TO CONTROL PRINTING DEVICE CONNECTED THERETO

(71) Applicant: BROTHER KOGYO KABUSHIKI KAISHA, Nagoya (JP)

(72) Inventor: Yoshito HOSOMIZO, Konan (JP)

(21) Appl. No.: 18/882,890

(22) Filed: Sep. 12, 2024

Related U.S. Application Data
(63) Continuation of application No. PCT/JP2023/008512, filed on Mar. 7, 2023.

(30) Foreign Application Priority Data
Mar. 16, 2022 (JP) 2022-041517

(51) Int. Cl. G06F 3/12

(52) U.S. Cl. CPC G06F 3/1205; G06F 3/1254; G06F 3/126

(57) ABSTRACT

Support program is configured to cause the information processing device to perform obtaining capability information from the printing device, and storing information based on the obtained capability information in a memory of the information processing device. In a case where execution of a process is required from a general-purpose print program in response to the printing device being selected on the print setting screen and the information based on the capability information is stored in the memory, the support program causes the information processing device to perform reading the information, generating display data for displaying a setting item reflecting the capability information on the print setting screen, and causing a display of the information processing device to display the print setting screen based on the display data by providing the display data to the general-purpose print program.

### REFERENCE TO RELATED APPLICATIONS

This application is a continuation of PCT International Application No. PCT/JP2023/008512 filed on Mar. 7, 2023, and claims priority from Japanese Patent Application No. 2022-041517 filed on Mar. 16, 2022, which are incorporated herein by reference in their entirety.

### BACKGROUND ART

The present disclosure relates to a non-transitory computer-readable recording medium containing computer-executable instructions which causes information processing device to control a printing device connected thereto.

In recent years, a technology has been put to practical use in which a printer is controlled by a general-purpose print program that is incorporated as standard into an operating system (hereinafter referred to as the “OS”) of an information processing device, without using a printer driver. In this technology, the OS associates the printer with the OS-standard general-purpose print program in response to detecting the printer, and thereafter, the information processing device is enabled to cause the printer to perform printing with the OS-standard general-purpose print program without using a printer driver in response to receiving a print instruction to the printer.

Conventional printers employing the general-purpose print program is typically configured such that, every time when a printer is selected, the general-purpose print program invokes activates a support program (an auxiliary program). The support program accesses the printer to obtain capability information of the printer, which is transferred to an application program via the general-purpose print program. However, if accessing to the printer as above is performed every time the printer is selected, delay of processing may occur.

### SUMMARY

According to aspects of the present disclosure, there is provide a non-transitory computer-readable recording medium containing computer-executable instructions that are executable by a computer of an information processing device and compatible with a printing device connected with the information processing device. The computer-executable instructions realize a support program supporting a general-purpose print program incorporated in advance in an operating system of the information processing device. The general-purpose print program is configured to handle data causing a display of the information processing device to display a print setting screen. The support program is configured to, when executed by the computer, cause the information processing device to perform obtaining capability information indicating capability of the printing device through communication with the printing device, and storing information based on the obtained capability information in a memory of the information processing device. In a case where execution of a process is required from the general-purpose print program in response to the printing device being selected on the print setting screen and the information based on the capability information is stored in the memory, the support program is configured to, without causing the information processing device to perform the obtaining, cause the information processing device to perform reading the information based on the stored capability information from the memory, generating display data for displaying a setting item reflecting the capability information on the print setting screen, with using the information based on the read capability information, and causing the display of the information processing device to display the print setting screen based on the display data by providing the display data to the general-purpose print program.

### BRIEF DESCRIPTION OF DRAWINGS

FIG. 1 is a block diagram schematically showing an electrical configuration of a PC.

FIG. 2 is a sequence chart showing an example of a procedure when “Print” is selected.

FIG. 3 shows an example of a print setting screen.

FIGS. 4A and 4B show examples of changed contents displayed on the print setting screen.

FIG. 5 shows another example of changed contents displayed on the print setting screen.

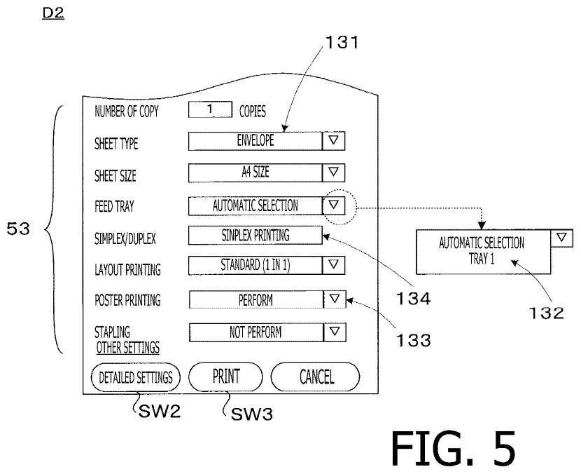

FIG. 6 is a sequence chart showing an example of a procedure when a print instruction has been received.

FIG. 7 is a sequence chart showing an example of a procedure when “Print” is selected according to a modified embodiment.

FIG. 8 is a sequence chart showing an example of a procedure when “Detailed Setting” is selected.

FIG. 9 shows an example of detailed setting screen.

FIG. 10 is a sequence chart showing an example of a procedure when “Print” is selected according to another modified embodiment.

FIG. 11 is a sequence chart showing an example of a procedure when “Print” is selected according to a further modified embodiment.

### DESCRIPTION

It is noted that various connections are set forth between elements in the following description. It is noted that these connections in general and, unless specified otherwise, may be direct or indirect and that this specification is not intended to be limiting in this respect. Aspects of the present disclosure may be implemented on circuits (such as application specific integrated circuits) or in computer software as programs storable on computer-readable media including but not limited to RAMs, ROMs, flash memories, EEPROMs, CD-media, DVD-media, temporary storage, hard disk drives, floppy drives, permanent storage, and the like.

In the present disclosure, an inclusive OR, meaning that it includes either A or B or both, may be expressed as “A and/or B,” “at least one of A or B,” or “at least one selected from the group consisting of A and B.”

A detailed explanation will be provided below of a personal computer (hereinafter referred to as the “PC”) using auxiliary programs in an illustrative embodiment according to aspects of the present disclosure, with reference to the accompanying drawings. In the present disclosure, the auxiliary programs executable by the PC are described. The auxiliary programs are examples of a support program according to aspects of the present disclosure.

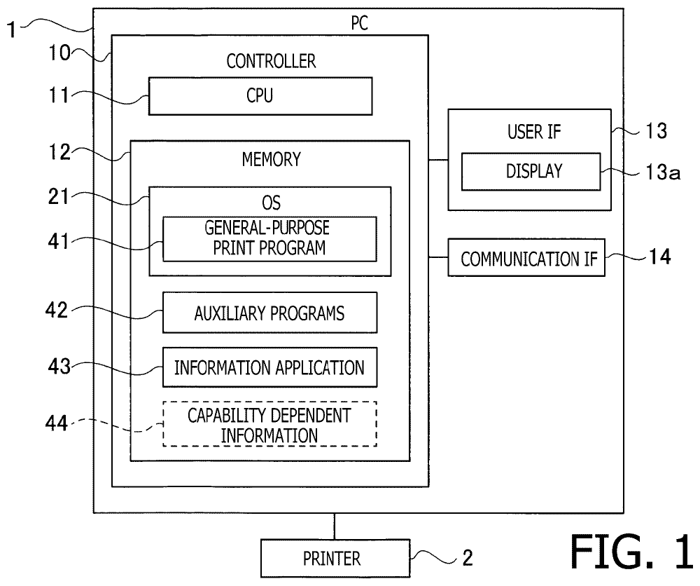

As shown in FIG. 1, a PC 1 of the illustrative embodiment has a controller 10 that includes a CPU 11 and a memory 12. The PC I may be an example of an “information processing device” according to aspects of the present disclosure. The CPU 11 may be an example of a “computer” according to aspects of the present disclosure. The PC 1 further includes a user interface (hereinafter referred to as the “user I/F”) 13 and a communication interface (hereinafter referred to as the “communication I/F”) 14, which are electrically connected with the controller 10. The “controller 10” in FIG. 1 is a collective term for hardware and software used to control the PC 1 and may not necessarily represent a single hardware element actually existing in the PC 1.

The CPU 11 is configured to perform various processes according to programs read from the memory 12 and based on user operations. The memory 12 stores various types of data and various programs. The memory 12 is also used as a work area when various processes are performed. A buffer provided to the CPU 11 may be an example of a “memory” according to aspects of the present disclosure. Examples of the memory 12 are not limited to a ROM, a RAM, and an HDD that are incorporated in the PC 1, but may include storage media (e.g., CD-ROMs and DVD-ROMs) that are readable and writable by the CPU 11.

The user I/F 13 includes hardware configured to display screens to provide information to the user, and hardware configured to receive user operations. The user I/F 13 may have a combination of a display 13a configured to display information, and a mouse and/or a keyboard that are configured to receive user input operations, i.e., having an input receiving function. The user I/F 13 may include a touch panel having the display 13a and the input receiving function. The user I/F 13 includes an example of a “display” according to aspects of the present disclosure.

The communication I/F 14 includes hardware configured to communicate with external devices such as a printer 2. Communication standards applicable for the communication I/F 14 include Ethernet (“Ethernet” is a registered trademark of Fuji Xerox Co., Ltd.), Wi-Fi (“Wi-Fi” is a registered trademark of the non-profit Wi-Fi Alliance), and USB. The PC 1 may be configured to connect with the Internet via the communication I/F 14. The PC 1 may have a plurality of communication I/Fs 14 conforming to a plurality of communication standards. The printer 2 may be an example of a “printing device” according to aspects of the present disclosure.

As shown in FIG. 1, the memory 12 of the PC 1 stores an operating system (hereinafter referred to as the “OS”) 21 including a general-purpose print program 41, and further stores auxiliary programs 42 and various application programs (hereinafter, which may be referred to as the “applications”). Examples of the OS 21 may include, but are not limited to, Windows (“Windows” is a registered trademark of Microsoft Corporation), macOS (“macOS” is a registered trademark of Apple Inc.), Linux (“Linux” is a registered trademark of Linus Torvalds), iOS (“iOS” is a registered trademark of Cisco Systems, Inc.), and Android (“Android” is a registered trademark of Google LLC).

The PC 1 in the illustrative embodiment incorporates various applications such as an information application 43. The information application 43 is, for instance, a map application, a calendar application, or a browser. The information application 43 is configured to, when executed by the CPU 11, cause the PC 1 to display various types of information on the display 13a in response to user requests. The information application 43 may be an example of an “application program” according to aspects of the present disclosure. The information application 43 itself may not necessarily have a function to print the displayed information.

The general-purpose print program 41 is an OS-standard program provided with the OS 21 and has a function to cause the printer 2 to print information that is displayed on the display 13a by the information application 43. The general-purpose print program 41 in the illustrative embodiment is a program having a function for generating intermediate image data based on image data to be printed. The general-purpose print program 41 supports functions that are usable in common by a plurality of printer models provided by vendor(s) of various printers. Unlike printer drivers that are specific to individual printers, the general-purpose print program 41 does not support all of the functions that are unique to the individual printers. Functions supportable by the general-purpose print program 41 are limited to generic functions.

The auxiliary programs 42 include one program or a group of programs configured to, when executed by the CPU 11, cause the PC 1 to perform processing based on instructions from the OS 21, accompanying processing by the general-purpose print program 41. The auxiliary programs 42 include one or more programs that support control of target hardware elements. The auxiliary programs 42 in the illustrative embodiment are compatible with a model of the printer 2 connected with the PC 1. The auxiliary programs 42 are launched from the general-purpose print program 41, for instance, when the PC 1 has received an instruction to cause the printer 2 to perform printing using the general-purpose print program 41. The auxiliary programs 42 are called, for instance, PSA (“PSA” is an abbreviation for “Print Support Application”) or HSA (“HAS” is an abbreviation for “Hardware Support Application”).

For instance, the auxiliary programs 42 may include a combination of a plurality of programs each of which is configured to, when executed by the CPU 11, cause the PC 1 to receive execution instructions. In another instance, the auxiliary programs 42 may include one program configured to, when executed by the CPU 11, cause the PC 1 to receive instructions and perform respective different processes according to the received instructions. The auxiliary programs 42 may include a program prepared for each type of printer by the printer vendor(s). For instance, the auxiliary programs 42 may include an auxiliary program prepared for inkjet printers and an auxiliary program prepared for laser printers. The auxiliary programs 42 may include not only the auxiliary program prepared for each type of printer but also an auxiliary program prepared for each model of printer or an auxiliary program prepared for each series of models of printers.

For instance, when a new printer is connected with the PC 1, the OS 21 may cause the PC 1 to download an appropriate auxiliary program from a server or another source depending on a type of the connected printer and to incorporate the downloaded auxiliary program into the PC 1. Then, the OS 21 may cause the PC 1 to store identification information of the incorporated auxiliary program in the memory 12 in association with printer information of the newly connected printer.

As shown in FIG. 1, the PC 1 in the illustrative embodiment is connected with the printer 2. The printer 2 has at least a printing function and a communication function. The printer 2 is configured to receive print data and print settings from an external device such as the PC 1 and perform printing according to the print settings.

The printer 2 is configured to receive print settings based on the functions that the printer 2 has. Further, the printer 2 is also configured to receive settings for processing options that the printer 2 can perform image processing, for example, a layout printing (e.g., N-in-1 printing). It is noted that the editing options may be realized by image processing performed by the auxiliary programs 42. The printer 2 does not receive the setting of editing options where the printer 2 cannot perform image processing but the auxiliary programs 42 perform the image processing. In other words, the printer 2 stores parameters for each item that can be set, depending on the capability of the printer 2.

The auxiliary programs 42 are configured to receive print settings via a print setting screen (hereinafter, which may be referred to as the “detailed setting screen”) dedicated to the printer 2. In addition to items for which the printer 2 can receive settings, the auxiliary programs 42 are configured to display on the detailed setting screen items for which the printer 2 cannot process images but the auxiliary programs 42 perform image processing, as described above, and receive settings. The auxiliary programs 42 are configured to store capability dependent information 44. The capability dependent information 44 is information indicating contents of setting items to be displayed on the print setting screen based on the capability information of the printer. The capability dependent information 44 is an example of “capability-based information.” The capability dependent information 44 is not stored in the memory 12 at the time of installation of the auxiliary programs 42, but is stored, for example, through communication with the printer 2. Details of the print setting screen and the capability dependent information 44 are described later.

The general-purpose print program 41 is configured to display a print setting screen and receive print settings. The general-purpose print program 41 is configured to handle data for displaying the print setting screen. For example, the general-purpose print program 41 is configured to receive display data based on the capability dependent information 44 from the auxiliary programs 42 and receive print settings via the print setting screen based on that display data.

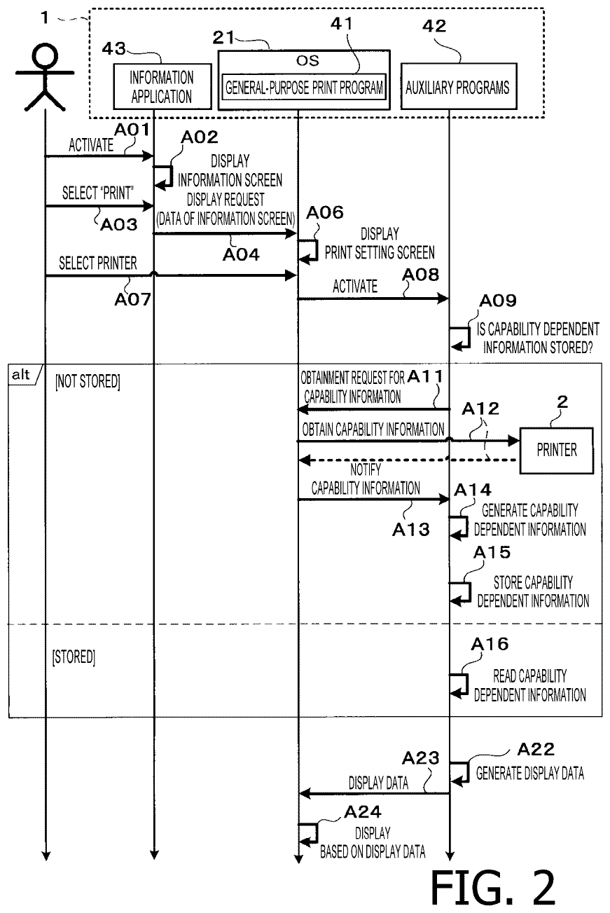

Next, an explanation will be provided of a procedure of printing that includes operations of the auxiliary programs 42 in the illustrative embodiment, i.e., a procedure of operations by the individual programs when printing is selected via the information application 43, with reference to a sequence chart in FIG. 2. In FIG. 2 and after-mentioned other sequence charts, operations when the auxiliary programs 42 compatible with the printer 2 are incorporated in the PC 1 are shown.

Each processing step in the processes and flowcharts in the illustrative embodiment basically indicates processing by the CPU 11 according to the instructions described in the auxiliary programs 42 and other programs. The processing by the CPU 11 includes hardware control using an API (“API” is an abbreviation for “Application Programming Interface”) of the OS 21. In the present disclosure, the operations by the individual programs may be described without a detailed explanation of the OS 21. In addition, “obtaining” and “acquiring” may be used as concepts that do not necessarily require a request.

At the beginning of the procedure, a user activates the information application 43 (A01). The information application 43 displays an information screen containing various types of information on the display 13a in response to a user's instruction (A02). If the user wishes to print an image of the information screen being displayed, the user selects “Print” on the information screen (A03). The information application 43 then sends a display request along with data of the information screen to the general-purpose print program 41 in the OS 21 (A04).

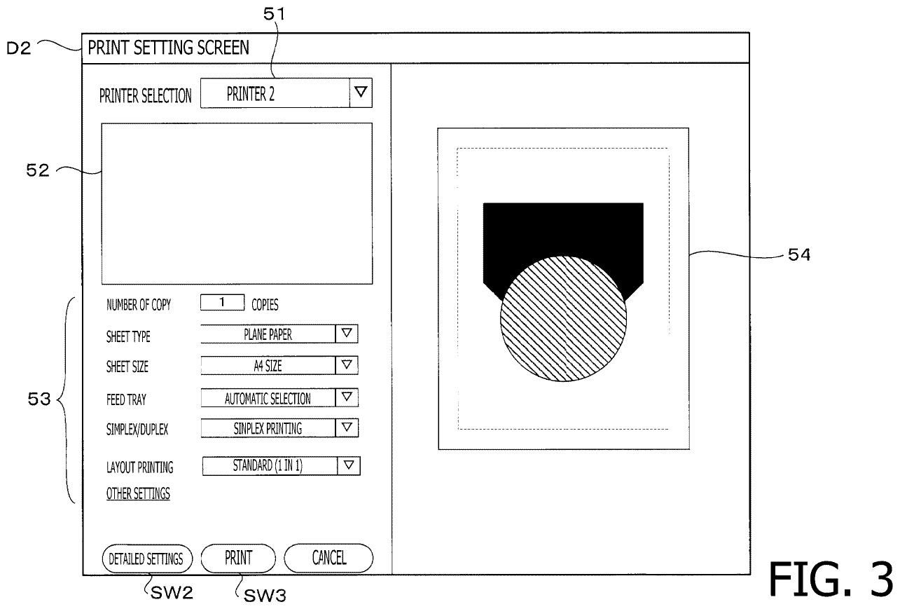

The general-purpose print program 41 displays a print setting screen on the display 13a in response to the display request (A06). The print setting screen is configured to receive instructions for print settings and a print execution instruction. For instance, as shown in FIG. 3, the print setting screen D2 includes a printer selection field 51, a notification field 52, a print setting field 53, a preview field 54, a detailed setting button SW2, and a print button SW3. The printer selection field 51 is configured to receive selection of a printer. The notification field 52 is configured to display a notification image. The print setting field 53 is configured to receive designations of various print settings. The preview field 54 is configured to display a preview of an image (i.e., a print target image) of the information screen. The detailed setting button SW2 is configured to receive instructions for detailed print settings. The print button SW3 is configured to receive a print execution instruction.

In the print setting field 53, print setting items concerning functions supported by the general-purpose print program 41 are displayed, and print setting values can be received. Examples of items that can be set through the print setting field 53 include the number of copies, an orientation of printing, a duplex printing, a layout printing (i.e., N-in-1 printing), a size of the printing sheet, a feed tray to be used, a printing range, a type of printing sheets, colors, borderless printing, scaling, and print quality (resolution). In the print setting field 53, only major items may be displayed to facilitate print settings, and other items may be additionally displayed when other settings operations are performed.

The notification image displayed in the notification field 52 is an image showing the contents to be notified to the user. The notification image may include, for example, text, still images, video, or a combination thereof.

As shown in FIG. 2, the user is allowed to select a printer by performing an operation on the printer selection field 51 on the print setting screen D2 being displayed (A07). When the printer 2 is selected, the general-purpose print program 41 activates the auxiliary programs 42 compatible with the printer 2 and sends to the auxiliary programs 42 a processing request for processing according to the selection of the printer 2 (A08). In A08, the general-purpose print program 41 passes information on the selected printer 2 and information on the print settings as set at the time of printer selection to the auxiliary programs 42.

When the printer 2 is set as a normally-used printer in the OS 21, the general-purpose print program 41 displays the print setting screen D2 with the printer 2 selected (A06) and activates the auxiliary programs 42 (A08). Namely, the printer 2 is automatically selected by the OS 21, and the general-purpose print program 41 executes A08 based on the information on the selected printer 2. In this case, the user operation in A07 is unnecessary.

Instead of the general-purpose print program 41 displaying the print setting screen D2, the information application 43 may be configured to display the print setting screen D2. In such a case, the information application 43 may activate the general-purpose print program 41 in response to “Print” being selected in A03, obtain data to be displayed on the print setting screen D2 from the general-purpose print program 41, and display the print setting screen D2 on the display 13a. Then, the information application 43 may pass the information on the selected printer 2 to the general-purpose print program 41 in response to the printer 2 having already been selected, or in response to the printer 2 being selected in A07. Thereby, the general-purpose print program 41 activates the auxiliary programs 42 compatible with the printer 2 in A08.

The auxiliary programs 42, in response to being activated, determine whether the capability dependent information 44 corresponding to the printer 2 has already been stored in the memory 12 (A09). For example, when the printer 2 is selected for printing for the first time after the installation of the auxiliary programs 42, the memory 12 does not store the capability dependent information 44 corresponding to the printer 2. In such a case (alt: not stored), auxiliary programs 42 request the OS 21 to obtain the capability information of the printer 2 (A11). Upon receiving a request from the auxiliary programs 42, the OS 21 transmits an acquisition request to the printer 2 to acquire capability information, and acquires the capability information from the printer 2 (A12). The OS 21 passes the capability information obtained from the printer 2 to the auxiliary programs 42 (A13). A11 to A13 may be examples of a capability obtaining process according to aspects of the present disclosure.

For example, the OS 21 performs communication according to IPP (“IPP” is an abbreviation for “Internet Printing Protocol”) with the printer 2. Instead of sending the request to the OS 21, for example, the auxiliary programs 42 may directly obtain the capability information from the printer 2 using MIB (“MIB” is an abbreviation for “Management Information Base”).

The capability information obtained from the printer 2 includes information on parameters that are settable as print settings. The capability information further includes, for instance, status information, information on remaining amounts of consumables, information on attached trays, sheet information on sheets set for each tray, and information on supported print resolutions. The printer 2 may have functions to perform image processing based on a received print job and perform printing based on data obtained after the image processing, e.g., functions to perform layout printing such as N in 1, composition printing such as printing an image combined with a watermark, and saving printing to save colorant. When the printer 2 has image processing functions executable thereon, the printer 2 may pass information on the image processing functions to the OS 21 as capability information.

The auxiliary programs 42, having obtained the capability information, generate the capability dependent information 44 based on the capability information (A14) and store the same in the memory 12 (A15). A14 and A15 are examples of a storing process.

For example, the auxiliary programs 42 determine the setting items to be displayed on the print setting screen D2 based on the capability information, and store the determined setting items in the memory 12 as the capability dependent information 44. Concretely, for example, it is assumed that the capability information obtained from the printer 2 includes information indicating that the printer 2 is equipped with “Tray 1,” “Tray 2,” and an “additional tray,” and that “envelopes” can be set in “Tray 1,” “plain paper” in “Tray 2,” and “cloth” in the “additional tray.” In such a case, the auxiliary programs 42 determine that “Auto Select,” “Tray 1,” “Tray 2,” and “Additional Tray” can be set as configuration parameters for the “Feed Tray” item, and that “Plain Paper,” “Envelope,” and “Cloth” can be set as configuration parameters for the “Paper Type” item, and store the contents of such information as the capability dependent information in the memory 12.

The capability dependent information 44 may include settings for processing options such as layout printing, booklet printing, or poster printing. The layout printing is a printing method in which images of N sheets of original documents are reduced and placed on one side of a sheet of paper, and printed. The booklet printing is a printing method in which images from the original document are reduced, rearranged, and printed by placing two pages on each side of the paper, one on the front and one on the back. Poster printing is a printing method in which the image of the original document is enlarged and divided into M pieces, and the divided images are placed on one side of M sheets of paper. For example, the booklet printing and the poster printing are items or parameters that cannot be processed by the printer 2, but can be realized by the auxiliary programs 42. In the present embodiment, the layout printing can be handled by both the printer 2 and the auxiliary programs 42, but the booklet and poster printing cannot be handled by the printer 2 and can be realized by the auxiliary programs 42.

As shown in FIG. 2, the auxiliary programs 42, which store the capability dependent information 44 in the memory 12, generate the display data using the capability dependent information 44 (A22). A22 may be an example of a generating process according to aspects of the present disclosure. The auxiliary programs 42 pass the generated display data to the general-purpose print program 41 (A23), which displays a print setting screen D2 reflecting the capability information on the display 13a (A24). A23 may be an example of a displaying process according to aspects of the present disclosure. The auxiliary programs 42 execute printing when the print button SW3 on the print setting screen D2 shown in FIG. 3 is operated.

After execution of A22 to A23, A01 to A6 are executed again. Then, when the general-purpose print program 41 is used to select printer 2 for printing (A07), the general-purpose print program 41 activates the auxiliary programs 42 in the same way as above (A08). In such a case, since the capability dependent information 44 is stored in the memory 12 (A09, alt: stored), the auxiliary programs 42 read the capability dependent information 44 from the memory 12 (A16), without executing the process of obtaining the capability information from the printer 2. A16 may be an example of a reading process according to aspects of the present disclosure. Then, the auxiliary programs 42 perform processes A22-A23 based on the capability dependent information 44 to display the print setting screen D2 reflecting the capability information on the display 13a.

In other words, when selecting a printer for the first time, the auxiliary programs 42 obtain the capability information from the printer 2, store the capability dependent information 44 in the memory 12, and generate the display data. The next time onwards, when the printer 2 is selected, the auxiliary programs 42 generate the display data using the capability dependent information 44 stored in the memory 12, without obtaining the capability information from the printer 2. Therefore, when selecting printer 2 next time onwards, it takes less time from the printer selection operation to the display of the print setting screen D2, which reflects the capability of the printer 2.

Instead of obtaining the capability information from the printer 2 when the printer 2 is selected for the first time (A09, alt: not stored, A11-A13), the capability information may be obtained from the printer 2 when a particular time has passed since the previous process of obtaining the capability information, and the like. According to this configuration, for example, when the capacity information changes after the capacity information is obtained, such as when an additional tray is attached to or detached from the printer 2, it is possible to display the print setting screen D2 in response to the change in capacity information.

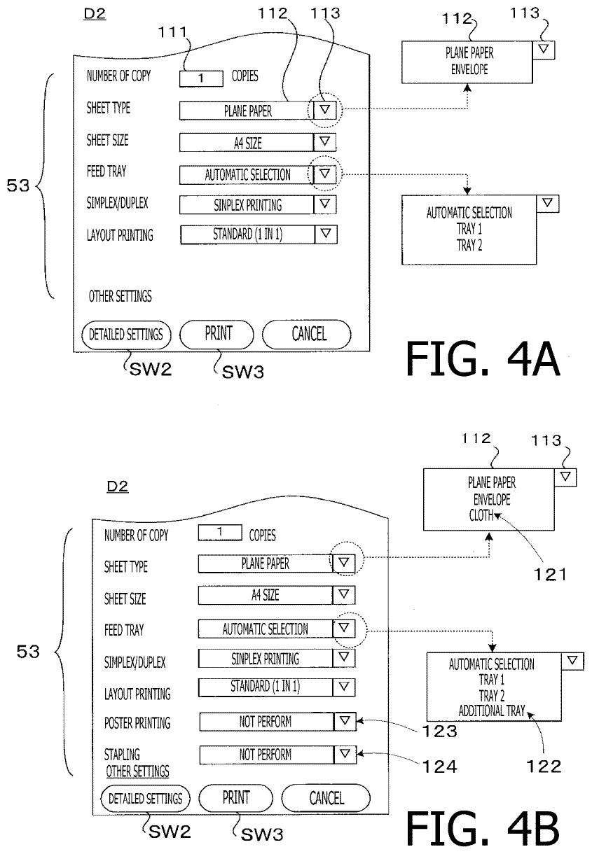

Hereinafter, a concrete description regarding the display of the print setting screen D2 will be explained. For example, in the print setting screen D2, which is displayed without using capability information, the items and parameters of the print settings supported by the general-purpose print program 41 are displayed in the print setting field 53, as shown in FIG. 4A. For each item, list boxes 112 and list buttons 113 are provided. When the list button 113 is operated using the user I/F 13, the parameters that can be set for that item are selectably displayed in the list box 112.

In the present embodiment, items “Number of Copy,” “Paper Size,” “Feed Tray,” “Simplex/Duplex,” and “Layout Printing” are displayed on the print settings screen D2. Further, in the “Paper Type” list box 112, “Plain Paper” and “Envelope” are selectably displayed as parameters, for example. Furthermore, in the list box for “Feed Tray,” as parameters, “Auto Selection,” “Tray 1” and “Tray 2” are selectably displayed, for example.

In contrast, in the print settings screen D2, which is displayed using the capability information, additional items or parameters are displayed for the print setting items or parameters displayed in the print setting screen D2 shown in FIG. 4A, as shown in FIG. 4B. For example, if the capability dependent information 44 includes the additional items “Poster Printing” and “Stapling,” then the additional items “Poster Print” and “Staple” will be displayed on the print setting screen D2, as shown by the arrows 123 and 124 in FIG. 4B.

As a further example, if the capability dependent information 44 includes “Cloth” as a parameter to be added to the item of “Paper Type” and “Additional Tray” as a parameter to be added to the item of “Feed Tray,” on the print setting screen D2, “Cloth” is additionally displayed in the list box 112 of the “Paper Type” as indicated by the arrow 121, and “Additional Tray” is additionally displayed in the list box 112 of the “Feed Tray” as indicated by the arrow 122 in FIG. 4B.

As described above, when the auxiliary programs 42 select a printer 2 and perform print settings after storing the capability dependent information 44 in the memory 12, the auxiliary programs 42 can display the print setting screen D2 on the display 13a that reflects the capability of the selected printer 2 or the capability of the auxiliary programs 42 compatible with the printer 2. Therefore, the user can make detailed print settings on the print setting screen D2 without operating the detailed setting button SW2 on the print setting screen D2 to display the detailed setting screen on the display 13a, thus saving time and effort in print settings.

Further, since the auxiliary programs 42 store the contents of the setting items to be finally displayed on the print setting screen D2 in the memory 12 as the capability dependent information 44, there is no need to execute a process to generate the capability dependent information 44 when generating the display data, thereby reducing the delay in displaying the print setting screen D2.

In addition, the auxiliary programs 42 may, for example, generate a notification image to notify that the number of items or parameters for print settings displayed on the print settings screen D2 has increased, and display the display data including the image in the notification field 52 of the print setting screen D2. The auxiliary programs 42 may generate display data including a message box containing a notification and display the message box on the print setting screen D2 separately from the notification field 52.

FIG. 3 shows an example of the print setting screen D2 having a single notification field 52. However, practicable examples of the features (e.g., the location, the shape, the size, and the count) of the notification field(s) 52 are not limited to the example shown in FIG. 3. The auxiliary programs 42 may obtain information on the notification field 52 from the general-purpose print program 41 and determine notification data to be displayed in the notification field 52 based on the obtained information. For instance, when there are a plurality of locations where the notification field 52 is allowed to be displayed, and the auxiliary programs 42 are enabled to specify a display location for the notification field 52 from among the plurality of locations, the auxiliary programs 42 may pass notification data that includes information specifying the display location to the general-purpose print program 41. In addition, when the auxiliary programs 42 are enabled to select a size of the notification field 52, the auxiliary programs 42 may pass information specifying the size of the notification field 52 to the general-purpose print program 41.

Instead of generating display data and passing the generated display data to the general-purpose print program 41, the auxiliary programs 42 may display information themselves. In this case, however, the auxiliary programs 42 need to display a screen separate from the print setting screen D2, which may complicate the display and increase the user's stress. When the information is displayed on the print setting screen D2 displayed by the general-purpose print program 41 of the OS 21, it is possible to simplify the display and reduce the user's stress.

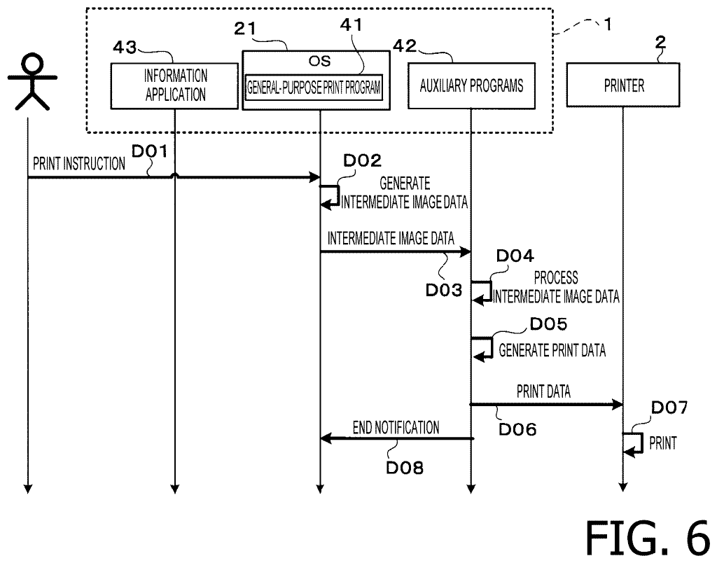

Next, an explanation will be given of procedures by the individual programs when a print execution instruction input by a user operation to the print button SW3 has been received while the print setting screen D2 shown in FIG. 3 is being displayed, with reference to a sequence chart in FIG. 6. The print execution instruction may be input by the user directly to the general-purpose print program 41, or may be input to the information application 43 and output from the information application 43 to the general-purpose print program 41. It is noted that, in the present disclosure, the print execution instruction may be referred to as the “print instruction.”

In response to receiving the user instruction to execute printing (D01), the general-purpose print program 41 generates intermediate image data by converting a format of image data representing a target image to be printed into a format of intermediate image data using the print settings accepted on the print setting screen D2 (D02), and then passes the generated intermediate image data to the auxiliary programs 42 (D03). The information application 43 includes various types of image data. The general-purpose print program 41 converts the image data to be printed into intermediate image data suitable for generating print data. If the image data to be printed is suitable for generating print data, generating the intermediate image data may be omitted. In this case, the image data to be printed may be used as intermediate image data. The intermediate image data is, for instance, XPS data.

The auxiliary programs 42 reflect the print settings configured in the auxiliary programs 42 in the intermediate image data received in D03, and thus edit the intermediate image data (D04). For example, if allocated printing (2-in-1) is set, the intermediate image data to be printed is reduced and placed on one side of the paper for two pages each. The auxiliary programs 42 rasterize the edited intermediate image data to generate print data representing the target image to be printed (D05). The print data generated in D05 is data (e.g., PDL data dedicated to the model of the printer 2) in a format usable for printing by the printer 2.

When the processed intermediate image data is rasterized by the auxiliary programs 42 compatible with the printer 2, the rasterization is achieved with a higher degree of freedom and it is more likely that print data suitable for printing by the printer 2 is generated than when rasterized by the general-purpose print program 41. The print data generated by the auxiliary programs 42 may be in a format usable by printers other than the model of the printer 2.

The auxiliary programs 42 transmit the print data generated in D05 to the printer 2 together with a print command for instructing the printer 2 to perform printing (D06). When there is image processing that has been determined to be performed by the printer 2, the auxiliary programs 42 generate a print command that includes information on the image processing. The auxiliary programs 42 further provides a notification that the transmission of the print data has been completed to the general-purpose print program 41 (D08). The general-purpose print program 41 cancels the transmission of the print data based on the notification.

The printer 2, which has received the print data and the print command, performs printing of the target image represented by the print data based on the received print command (D07). Thus, a printed material is generated.

Instead of the auxiliary programs 42 generating the print data, the general-purpose print program 41 may generate the print data. For instance, the auxiliary programs 42 may pass the intermediate image data edited in D04 and information on printing to be executed to the general-purpose print program 41. Then, the general-purpose print program 41 may rasterize the processed intermediate image data to generate the print data. In this case, the general-purpose print program 41 may pass the generated print data to the auxiliary programs 42. In response to receiving the print data from the general-purpose print program 41, the auxiliary programs 42 send the received print data to the printer 2 together with the print command for instructing the printer to perform printing.

The print data generated by the general-purpose print program 41 is print data (e.g., PWG Raster data or PDF data) in a format usable for printing by various types of printers. If rasterization is performed by the general-purpose print program 41, it results in a smaller amount of processing by the auxiliary programs 42, thereby avoiding an increase in processing time, and reducing a program size of the auxiliary programs 42.

The general-purpose print program 41 may send the print data and the print command to the printer 2. Namely, the auxiliary programs 42 may pass the generated print data to the general-purpose print program 41, to be sent from the PC 1 with the printer 2 as a destination. In such a case, the general-purpose print program 41 may send the print data received from the auxiliary programs 42 to the printer 2.

As described above, the auxiliary programs 42 in the present embodiment is configured to communicate with the printer 2 to obtain the capability information, and store the capability dependent information 44, including the items or parameters of the print settings determined based on the capability information, in the memory 12 of the PC 1. When the auxiliary programs 42 are requested by the general-purpose print program 41 to perform a process due to the selection of printer 2 with the capability dependent information 44 stored in the memory 12, the auxiliary programs 42 do not perform processes (e.g., A11-A12 in FIG. 2) that require communication with the printer 2, and instead the auxiliary programs 42 display the contents of the setting items that reflect the capability information stored in the memory 12 on the print setting screen D2. In this way, the PC I has fewer opportunities to communicate with the printer 2 when the printer 2 is selected, and delays in processing associated with communication with the printer 2 are suppressed.

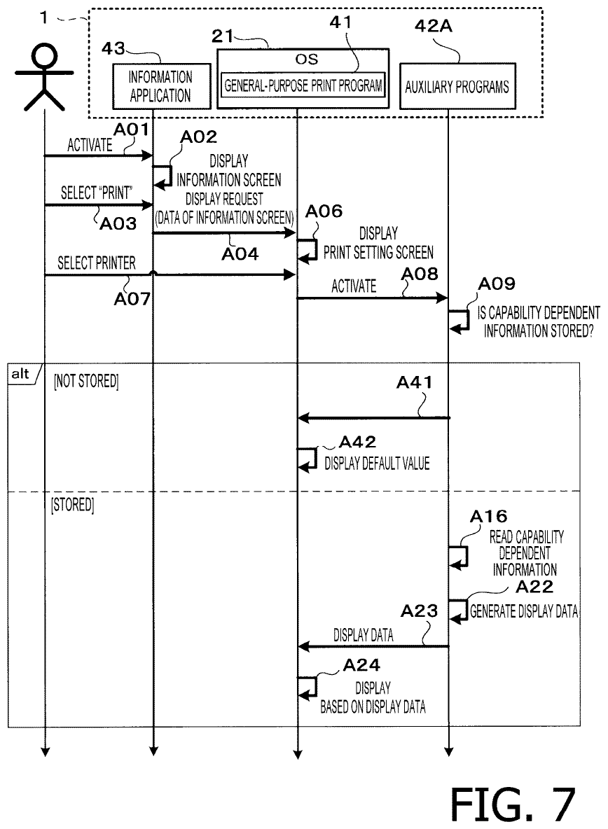

A modified embodiment of the auxiliary programs is then explained with reference to FIG. 7 through FIG. 9. The modified embodiment differs from the above-described embodiment in that a process for acquiring the capability information and storing the capability dependent information 44 in the memory 12 is performed at a timing when the detailed setting screen is displayed, rather than at a timing when the printer 2 is selected. The following description focuses on points that differ from the above-described embodiment, while the same symbols as in the above-described embodiment are used for common components, and explanations thereof are omitted as appropriate.

As shown in FIG. 7, when the printer 2 is selected and started by the general-purpose print program 41 while the capability dependent information 44 is not stored in the memory 12 (A07-A09, alt: not stored), the auxiliary programs 42A do not perform processing related to the display of the print setting screen D2 to the OS 21, but processing for the general-purpose print program 41 is performed (A41). Therefore, the general-purpose print program 41 displays the default values on the print setting screen D2 (A42). In such a case, the items or parameters of the print settings displayed on the print setting screen D2 are not changed and the setting values are set to default values.

It is noted that the auxiliary programs 42A may be configured to pass the display data for displaying the notification image to be displayed in the notification field 52 of the print setting screen D2 to the general-purpose print program 41. The notification image is an image that notifies the user that if the detailed print settings are made by operating, for example, the detailed setting button SW2, the user can make detailed print settings on the print setting screen D2 from the next time onward. According to the above configuration, utilization of the function of the auxiliary programs 42 to reflect the capability information of the printer 2 in the print setting screen D2 is facilitated.

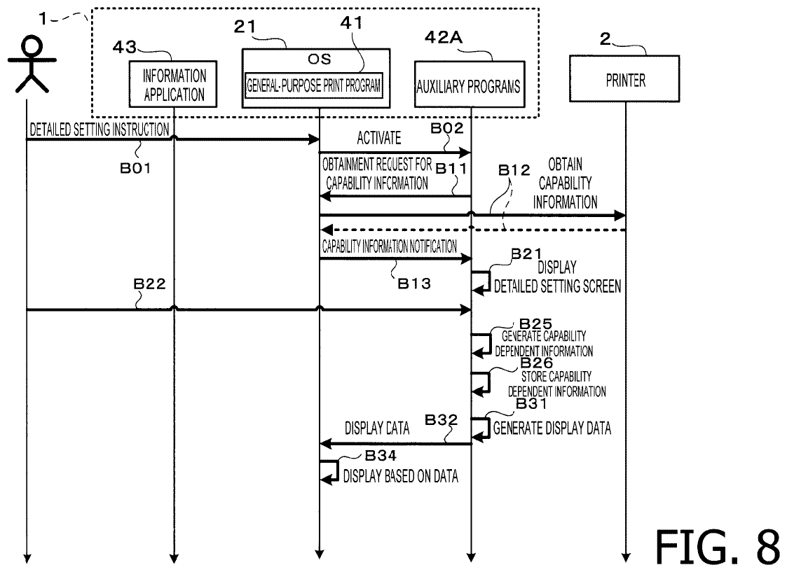

Procedures by each program when an instruction for detailed settings by user operation to the detailed setting button SW2 is accepted during the display of the print setting screen D2 shown in FIG. 3 are described with reference to FIG. 8. The instructions that the general-purpose print program 41 accepts via the detailed setting button SW2 may be examples of a display instruction according to aspects of the present disclosure.

The general-purpose print program 41 activates the auxiliary programs 42A (B02) based on the instruction by the user for detailed settings (B01). The general-purpose print program 41 passes the print settings set in the print setting field 53 of the print setting screen D2 to the auxiliary programs 42A.

The auxiliary programs 42A obtain the capability information from the printer 2 in response to being activated (B11 to B13). B11 to B13 may be examples of a capability acquisition process according to aspects of the present disclosure. Since the processing of B11 through B13 is similar to that of A11 through A13 in FIG. 2, the description is omitted.

After obtaining the capability information, the auxiliary programs 42A display the detailed setting screen on the display 13a and receive detailed print settings (B21). B21 may be an example of a displaying process of a detailed setting screen and a receiving process according to aspects of the present disclosure.

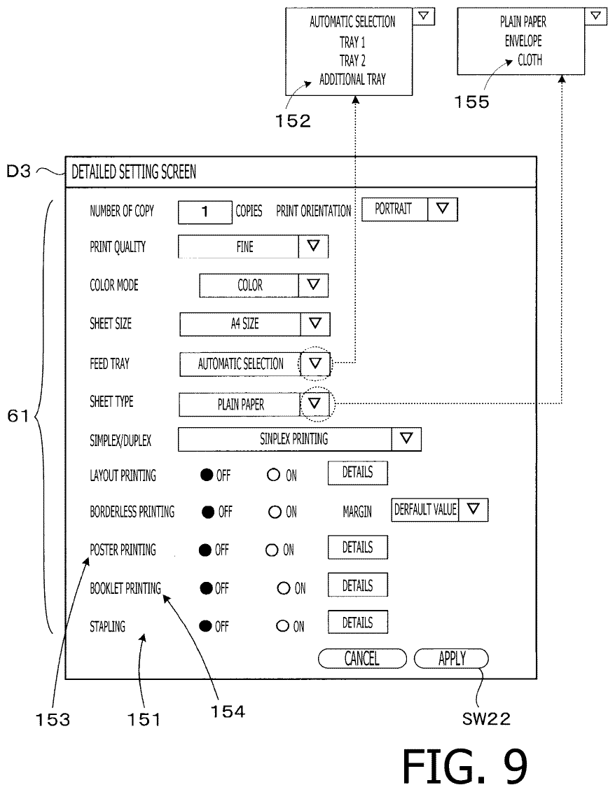

For example, as shown in FIG. 9, a detailed setting field 61 and an apply button SW22 are displayed on the detailed setting screen D3. In the detailed setting field 61, items and parameters for print settings based on the capability information obtained from the printer 2 in B11 through B13 are displayed. Further, in the detailed setting field 61, the setting items and parameters of editing options that are not processed by the printer 2 but by the auxiliary programs 42A are displayed. In other words, in the detailed setting field 61, additional items, which are items added to the print setting items that can be set in the general-purpose print program 41, or additional parameters, which are parameters added to the parameters that can be set in the general-purpose print program 41, are displayed based on the capability information of the printer 2.

“Stapling” indicated by the arrow 151 in FIG. 9 on the detailed settings screen D3 is an example of an additional item. “Poster Printing” shown by arrow 153 and “Booklet Printing” shown by arrow 154 in FIG. 9 are other examples of the additional item. “Additional Tray” shown by arrow 152 and “cloth” shown by arrow 155 in FIG. 9 are examples of an additional parameter. The auxiliary programs 42A can receive setting values for each item via the detailed setting screen D3.

Referring back to FIG. 8, the auxiliary programs 42A receive operations via the user I/F 13 (B22). For example, when receiving an instruction to complete the detailed print settings by operating the apply button SW22 shown in FIG. 9, the auxiliary programs 42A generate (B25) and store (B26) the capability dependent information 44 based on the additional items or additional parameters received via the detailed setting screen D3. B25 and B26 may be examples of a storing process according to aspects of the present disclosure. The auxiliary programs 42A according to the present embodiment is configured to store in the memory 12 all of the additional items or additional parameters that can be set via the detailed setting screen D3 as the capability dependent information 44. That is, the capability dependent information 44 includes not only the additional items or additional parameters set in the detailed setting screen D3, but also the additional items or additional parameters that were not set in the detailed setting screen D3, as objects to be displayed in the print setting screen D2.

Referring back to FIG. 8, the auxiliary programs 42A, which stored the capability dependent information 44 in the memory 12, generate display data based on the capability dependent information 44 (B31) and pass the data to the general-purpose print program 41 (B32). The general-purpose print program 41 displays the display data received from the auxiliary programs 42A on the print setting screen D2 (B33). The processes of B31 through B33 are similar to those of A22 through A24 in FIG. 2, so the description thereof is omitted. When the print button SW3 on the print setting screen D2 is operated, the auxiliary programs 42 perform the process shown in FIG. 6 described above.

After the process in FIG. 8, when the processes A01-A06 shown in FIG. 7 are performed again, and the printer 2 is selected to print using the general-purpose print program 41 (A07), the auxiliary programs 42A read the capability dependent information 44 from the memory 12 (A08, A09, alt: stored, A16) in response to activation by the general-purpose print program 41. The capability dependent information 44 contains all the additional items or additional parameters of the detailed setting screen D3. Therefore, the auxiliary programs 42A can use the capability dependent information 44 to generate display data to display all the contents of the setting items of the printer 2 or auxiliary programs 42A on the print setting screen D2 (A22) and pass the data to the general-purpose print program 41 to be displayed on the print setting screen D2 (A23, A24).

In such a case, the print setting screen D2 is configured to receive settings for all items or parameters of the print settings settable for the printer 2 or the auxiliary programs 42A, and can be substituted for the detailed setting screen D3. Therefore, the auxiliary programs 42A may generate display data indicating contents that do not display the detailed setting butto SW2 shown in FIG. 3 on the print setting screen D2, and may hide the detailed setting button SW2 of the print setting screen D2. That is, the auxiliary programs 42A may generate display data indicating display contents that limit receiving of display instructions to display the detailed setting screen D3 on the display 13a. In this way, it is possible to avoid unnecessary operations in which the user operates the detailed setting button SW2 to display the detailed setting screen D3 for the print setting items or parameters that can be set on the print setting screen D2.

It should be noted that the display instructions may be received not only by the detailed setting button SW2, but also by other objects such as a link (e.g., an indication representing a URL). The mode of restriction is not limited to non-display, but may be such as displaying objects that receive display instructions by grayout.

Instead of storing all the additional items or additional parameters of the detailed setting screen D3 in the memory 12 as the capability dependent information 44, the auxiliary programs 42A may store only the additional items or additional parameters that are set in the detailed setting screen D3 as the capability dependent information 44 in the memory 12.

Concretely, for example, it is assumed that “On” (i.e., enabled) is set for the additional item “Booklet Printing” and “Off” (i.e., disabled) is set for the additional items “Poster Printing” and “Stapling.” In such a case, the auxiliary programs 42A may include ““Booklet Printing”” in the capability dependent information 44, but may not include “Poster Printing” and “Stapling” in the capability dependent information 44. For another example, it is assumed, for example, that “Additional Tray” is set as an additional parameter for “Feed Tray” and “Plain Paper” is set as a non-additional parameter for “Paper Type” on the detailed setting screen D3. In such a case, the auxiliary programs 42A may include “Additional Tray” in the capability dependent information 44, but may not include “Cloth” in the capability dependent information 44.

According to the above configuration, the auxiliary programs 42A can display on the print setting screen D2 the additional items or additional parameters that have been set on the detailed setting screen D3 when the printer 2 is selected next time and print settings are made. As a result, the user can make settings for items or parameters for the print settings set on the detailed settings screen D3 without starting the detailed settings screen D3 after starting the print setting screen D2, thereby saving time and effort for print settings. Further, the user can select items or parameters among the print settings displayed on the detailed setting screen D3 to be used and displayed on the print setting screen D2.

In such a case, however, the user needs to launch the detailed setting screen D3 to set any additional items (e.g., poster printing, stapling) or additional parameters (e.g., cloth) that were not set on the detailed setting screen D3. If the auxiliary programs 42A display all additional items or additional parameters on the print settings screen D2, it will be possible to set other items or other parameters on the print setting screen D2 that were not set on the detailed setting screen D3, reducing the time and effort required for the user when making print settings. On the other hand, if all the items and parameters are displayed on the print setting screen D2, the screen can easily become complicated. By displaying only the items or parameters the user selected on the print setting screen D2, the screen becomes less complicated.

As described above, when the auxiliary programs 42A according to the present embodiment receive a display instruction to display the detailed setting screen D3, the auxiliary programs 42A communicate with the printer 2 to obtain the capability information and store the capability dependent information 44 including the items or parameters of the print settings determined based on the capability information in the memory 12 of the PC 1 (FIG. 8, B11-B13, B25, B26). When the auxiliary programs 42A receive a request for processing from the general-purpose print program 41 due to the selection of the printer 2 while the capability dependent information 44 is stored in the memory 12, the auxiliary programs 42A do not perform processing that requires communication with the printer 2, such as processes B11 through B13 in FIG. 8, but instead use the capability dependent information 44 stored in the memory 12 to display the contents of the setting items that reflect the capability information on the print setting screen D2 (A9, alt: stored, A16 through A23 in FIG. 7). In this way, the PC 1 has fewer opportunities to communicate with the printer 2 when the printer 2 is selected, and delays in processing associated with communication with the printer 2 are suppressed.

Further, when the auxiliary programs 42A display the detailed setting screen D3, it is likely that the user is requesting a setting based on the capabilities intrinsic to the printer 2 or the capabilities that can be realized by the auxiliary programs 42A. The auxiliary programs 42A according to the present embodiment obtain the capability information at the timing of displaying the detailed setting screen D3, and store the capability dependent information 44 generated based on the capability information in the memory 12. Therefore, the auxiliary programs 42A will be able to set items or parameters intrinsic to the printer 2, or items or parameters that can be realized by the auxiliary programs 42A, in the print setting screen D2, thereby increasing convenience.

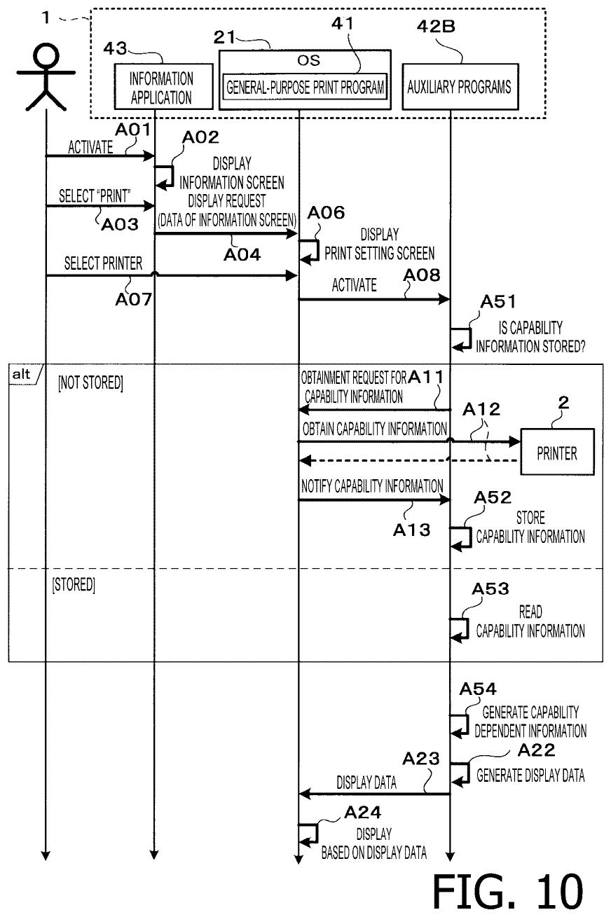

Next, another modified embodiment according to aspects of the present disclosure will be described with reference to FIG. 10. The present modified embodiment differs from the above-described embodiment in that the capability information obtained from the printer 2 is stored in the memory 12, and the stored capability dependent information 44 is used each time the display data is generated. In the following description, differences from the above-described embodiment will be focused on, and common elements will be assigned with the same symbols as in the above-described embodiment and description thereof will be omitted as appropriate.

As shown in FIG. 10, when the auxiliary programs 42B are activated by the general-purpose print program 41 with the printer 2 selected (A07, A08), the auxiliary programs 42B determine whether the capability information is stored in the memory 12 (A51). If the auxiliary programs 42B determines that the capability information is not stored in the memory 12 (alt: not stored), the auxiliary programs 42B obtain the capability information from the printer 2 (A11-A13) and store the obtained capability information in the memory 12 as it is (A52). A11-A13 may be examples of a capability obtaining process according to aspects of the present disclosure. A52 may be an example of a storing process according to aspects of the present disclosure. The capability information may be an example of information based on the capability information according to aspects of the present disclosure. Thereafter, the auxiliary programs 42B proceeds to A54

On the other hand, if the auxiliary programs 42B determines that the capability information is stored in the memory 12 (alt: stored), the auxiliary programs 42B read the capability information from the memory 12 (A53) and proceed to A54. A53 may be an example of a reading process according to aspects of the present disclosure.

In A54, the auxiliary programs 42B generate the capability dependent information 44 based on the capability information obtained in A11-A13 or read from the memory 12 in A53. Since A54 is the same process as A14 in FIG. 2, the description thereof is omitted. The auxiliary programs 42B generate display data using the capability dependent information 44 generated in A54, and display the print setting screen D2 reflecting the capability information of the printer 2 on the display 13a (A22-A24).

The auxiliary programs 42B according to the present embodiment communicate with the printer 2 to obtain the capability information, which is stored in the memory 12 of the PC 1. When the auxiliary programs 42B are requested by the general-purpose print program 41 to perform processing due to the selection of printer 2 with the capability information stored in the memory 12, the auxiliary programs 42B do not perform processing that requires communication with the printer 2 as shown in A11-A13, but instead, based on the capability information stored in the memory 12, the auxiliary programs 42B generate the capability dependent information 44 and display the contents of the setting items reflecting the capability information on the print setting screen D2 using the generated capability dependent information 44. As a result, in the PC 1, the opportunity to communicate with the printer 2 when the printer 2 is selected is reduced, and delays in processing associated with communication with the printer 2 are suppressed.

Furthermore, the auxiliary programs 42B according to the present embodiment can finish the storing process shown in A52 earlier by storing the capability information in the memory 12 before determining the capability dependent information 44.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential alternatives, modifications, or variations according to aspects of the present disclosure are provided below.

For instance, the device connected with the PC 1 is not limited to printer 2, but may be any device (e.g., multi-function peripheral, copier, and fax machine) having a printing function. The number of printers 2 connected with the PC 1 is not limited to the example (i.e., one) shown in the relevant drawings, but may be two or more.

It is noted that the information based on the capability information stored in the memory 12 does not have to be the capability dependent information 44 or capability information, but may be information in an intermediate process of generating the capability dependent information from the capability information. Alternatively, the information based on the capability information stored in the memory 12 may be information that has a converted data format such as compressed or decompressed.

The auxiliary programs 42, 42A, 42B may perform a process of obtaining the capability information from the printer 2 when installation is completed. In such a case, some processes, for example, the processes A11-A13 shown in FIG. 10 or the processes B11-B13 shown in FIG. 8 may be omitted.

When the auxiliary programs 42B generate the capability dependent information 44 including all additional items or additional parameters at BB25 in FIG. 8, the auxiliary programs 42B do not have to generate the display data which is configured to hide the detailed setting button SW2 at B26.

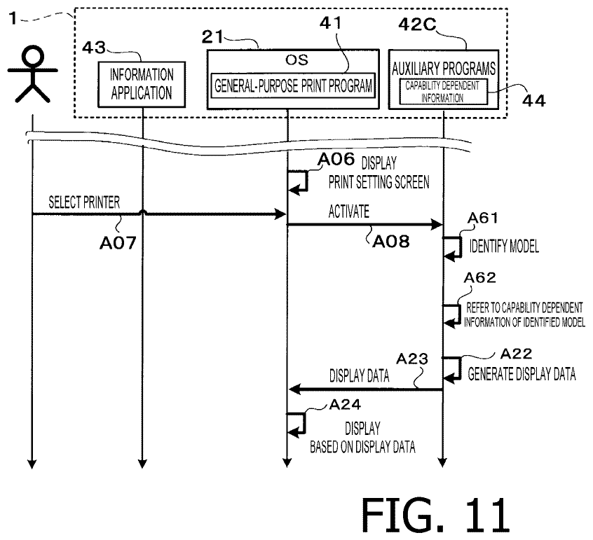

As shown in FIG. 11, auxiliary programs 42C may statically have capability dependent information 44 for each model. In such a case, when selecting the printer 2, auxiliary programs 42C may identify the model of the printer 2 (A61) based on the printer 2 information passed from the general-purpose print program 41 at A08. The auxiliary programs 42C generate the display data (A22) by referring to the capability dependent information 44 corresponding to the identified model (A62). Since the auxiliary programs 42C do not obtain capability information from the printer 2, but generates display data using the statically held capability reliance information 44, the opportunity for communication with the printer 2 when the printer 2 is selected is reduced, and the processing delay associated with communication with the printer 2 is suppressed. It should be noted that the auxiliary programs 42C may statically have the capability information for each model of the printer 2 instead of the capability dependent information 44. In such a case, the auxiliary programs 42C may generate the display data by identifying the model of the selected printer (A61) and then generating the capability dependent information 44 by referring to the capability information.

The general-purpose print program 41 may activate the auxiliary programs 42, 42A, 42B and 42C, when, after the print setting screen D2 is displayed by the general-purpose print program 41, the normally-used printer is changed from another printer to the printer 2 via the OS 21 by a user operation. In such a case as well, in substantially the same manner as when the printer 2 is selected, the auxiliary programs 42, 42A, 42B and 42C may perform may perform a process of obtaining the ability information from the printer 2, or the display data generation process and pass the generated display data to the general-purpose print program 41.

In the aforementioned illustrative embodiment, only the printing operation has been described in detail as the operation by the auxiliary programs 42, 42A, 42B and 42C. However, the auxiliary programs 42, 42A, 42B and 42C may further have other roles. Examples of the program to perform the processing in the aforementioned illustrative embodiment are not limited to the auxiliary programs 42, 42A, 42B and 42C, but may include any program configured to accept instructions from the OS 21 or the general-purpose print program 41 when printing is performed using the general-purpose print program 41. For instance, a print workflow application (Print workflow) whose specifications have been published by Microsoft Corp. may be included in the examples of the program to perform the processing in the aforementioned illustrative embodiment.

Practicable examples of the execution timing for executing the auxiliary programs 42, 42A, 42B and 42C are not limited to the example in the aforementioned illustrative embodiment. For instance, the auxiliary programs 42 may be executed in response to a direct execution instruction from the OS 21. In another instance, the auxiliary programs 42, 42A, 42B and 42C may be resident programs. In this case, the auxiliary programs 42, 42A, 42B and 42C may perform the aforementioned operations in response to receiving execution commands.

In any flowchart disclosed in the aforementioned illustrative embodiment, a plurality of processes in a plurality of any steps may be arbitrarily changed in the execution order thereof or may be executed in parallel as long as there is no inconsistency in the processing results.

The processing disclosed in the aforementioned illustrative embodiment may be performed by one or more CPUs, one or more hardware elements such as ASICs, or a combination of at least two selected therefrom. The processing disclosed in the aforementioned illustrative embodiment may be implemented in various aspects such as a non-transitory computer-readable storage medium storing computer-readable instructions (e.g., programs) for performing the processing, or a method for performing the processing.

What is claimed is:

1. A non-transitory computer-readable recording medium containing computer-executable instructions that are executable by a computer of an information processing device and compatible with a printing device connected with the information processing device, the computer-executable instructions realizing a support program supporting a general-purpose print program incorporated in advance in an operating system of the information processing device, the general-purpose print program being configured to handle data causing a display of the information processing device to display a print setting screen, the support program being configured to, when executed by the computer, cause the information processing device to perform:
obtaining capability information indicating capability of the printing device through communication with the printing device; and
storing information based on the obtained capability information in a memory of the information processing device;
wherein, in a case where execution of a process is required from the general-purpose print program in response to the printing device being selected on the print setting screen and the information based on the capability information is stored in the memory, the support program is configured to, without causing the information processing device to perform the obtaining, cause the information processing device to perform:
reading the information based on the stored capability information from the memory;
generating display data for displaying a setting item reflecting the capability information on the print setting screen, with using the information based on the read capability information; and
causing the display of the information processing device to display the print setting screen based on the display data by providing the display data to the general-purpose print program.

2. The non-transitory computer-readable recording medium according to claim 1,
wherein the support program is configured to, when executed by the computer, cause the information processing device to perform:
determining, in the storing, contents of a setting item to be displayed on the print setting screen based on the capability information obtained in the obtaining, and storing, in the storing, the contents of the determined setting item as the information based on the capability information in the memory of the information processing device; and
generating, in the generating, the display data for displaying the contents of the setting item, which is the information based on the capability information read in the reading.

3. The non-transitory computer-readable recording medium according to claim 1,
wherein the support program is configured to, when executed by the computer, cause the information processing device to perform:
storing, in the storing, the information based on the obtained capability information in the memory of the information processing device without determining contents of a setting item to be displayed on the print setting screen; and
determining, in the generating, the contents of the setting item to be displayed on the print setting screen based on information the capability information read in the reading, and generating, in the generating, the display data for displaying the determined contents of the setting item.

4. The non-transitory computer-readable recording medium according to claim 1,
wherein, in a case where execution of a process is required from the general-purpose print program in response to the printing device being selected on the print setting screen and the information based on the capability information is not stored in the memory, the support program is configured to, when executed by the computer, cause the information processing device to perform the obtaining and the storing.

5. The non-transitory computer-readable recording medium according to claim 1,
wherein the support program has a function to cause the display of the information processing device to display a detailed setting screen configured to receive print setting compatible with the printing device, and the general-purpose print program is configured to receive a display instruction of the detailed setting screen, and
wherein, in a case where execution of a process is required from the general-purpose print program in response to the general-purpose print program receiving the display instruction of the detailed setting screen, the support program is configured to, when executed by the computer, cause the information processing device to perform:
the obtaining;
causing the display of the information processing device to display the detailed setting screen configured to receive the print setting compatible with the printing device based on the capability information obtained in the obtaining; and
the storing.

6. The non-transitory computer-readable recording medium according to claim 5,
wherein the support program is configured to, when executed by the computer, cause the information processing device to perform:
receiving the print setting on the detailed setting screen, an item or a setting parameter of print setting having been added to contents of a setting item of print setting settable by the general-purpose print program on the detailed setting screen based on the capability information obtained in the obtaining;
in a case where an additional item which is the item added based on the capability information or an additional setting parameter which is the setting parameter added based on the capability information is set to the print setting received in the receiving, storing, in the storing, the additional item or the additional setting parameter in the memory of the image processing device as information based on the capability information; and
generating, in the generating, the display data for displaying the additional item or the additional setting parameter indicated by the information based on the capability information read in the reading.

7. The non-transitory computer-readable recording medium according to claim 5,
wherein the support program is configured to, when executed by the computer, cause the information processing device to perform:
receiving the print setting on the detailed setting screen, an item or a setting parameter of print setting having been added to contents of a setting item of print setting settable by the general-purpose print program on the detailed setting screen based on the capability information obtained in the obtaining;
storing, in the storing, all of an additional item which is the item added based on the capability information and an additional setting parameter which is the setting parameter added based on the capability information in the memory of the image processing device as information based on the capability information; and
generating, in the generating, the display data for displaying all of the additional item and the additional setting parameter indicated by the information based on the capability information read in the reading.

8. The non-transitory computer-readable recording medium according to claim 7,
wherein the support program is configured to, when executed by the computer, cause the information processing device to perform generating, in the generating, the display data indicating display contents limiting receiving of the display instruction.

9. The non-transitory computer-readable recording medium according to claim 1,
wherein in a case where execution of a process is required from the general-purpose print program in response to a print instruction which instructs the general-use printing program to cause the printing device to print an image and is output by an application program implemented in the information processing device, the support program is configured to, when executed by the computer, cause the information processing device to perform obtaining image data indicating the image from the general-purpose print program and transmitting a print command to the printing device based on the image data.
